(19) United States
(12) Patent Application Publication
(10) Pub. No.: US 2015/0006595 A1
(43) Pub. Date: Jan. 1, 2015

(54) APPARATUS AND METHOD FOR RECONFIGURING EXECUTION FILE IN VIRTUALIZATION ENVIRONMENT

(71) Applicant: ELECTRONICS AND TELECOMMUNICATIONS RESEARCH INSTITUTE, Daejeon-city (KR)

(72) Inventors: Yangseo CHOI, Daejeon (KR); Byoungkoo KIM, Daejeon (KR); Ikkyun KIM, Daejeon (KR)

(73) Assignee: ELECTRONICS AND TELECOMMUNICATIONS RESEARCH INSTITUTE, Daejeon-city (KR)

(21) Appl. No.: 14/313,659

(22) Filed: Jun. 24, 2014

(30) Foreign Application Priority Data
Jun. 26, 2013 (KR) 10-2013-0073470

(51) Int. Cl. G06F 17/30; G06F 9/455

(52) U.S. Cl. CPC G06F 17/30233; G06F 17/30194; G06F 9/45533
USPC 707/827

(57) ABSTRACT

Disclosed herein are an apparatus and method for reconfiguring an execution file in a virtualization environment. The apparatus for reconfiguring the execution file in a virtualization environment includes collecting packets transmitted and received through a virtual switch in the virtual environment, extracting execution file packet including execution file from the collected packets, sequentially collecting session packets belonging to a session identical with the session of the execution file packets, and reconfiguring the execution file based on a result of check for an application protocol of each of the session packets.

Priority to Korean patent application number 10-2013-0073470 filed on Jun. 26, 2013, the entire disclosure of which is incorporated by reference herein, is claimed.

### BACKGROUND OF THE INVENTION

1. Field of the Invention

The present invention relates to an apparatus and method for reconfiguring an execution file in a virtualization environment and, more particularly, to an apparatus and method for extracting packets related to a Windows execution file from network packets, transmitted and received over a virtual network in a server virtualization environment, and reconfiguring the execution file.

2. Discussion of the Related Art

Server virtualization is technology in which a plurality of Operating Systems (OSs) is installed in one physical computer and driven like multiple systems. That is, the server virtualization technology enables multiple applications, middleware and OSs to be driven at the same time without a need to know each other and without affecting each other in one server. Today, VMware, Microsoft, and Citrix are taking the lead in the market.

In a computer environment to which server virtualization has been applied, malicious code that can search for a virtual machine and affect the retrieved virtual machine has recently emerged. Symantec said that it has discovered malicious code “Crisis” which infects VMware virtual machine environments, Windows mobile devices, and USB drives in addition to the MAC OS and the Windows OS through its blog.

Crisis wears camouflage as a Java applet used in flash update, deceives a user, and infects a computer. Such Crisis captures a user's e-mail, text messages, and website visit records. Crisis can snatch a telephone call record through Skype, track traffic occurring in a messenger, and view a website visit record using a web browser, such as Firefox or Safari.

In general, pieces of malicious code generated so far have been programmed to not perform malicious behaviors on virtual machines because vaccine manufacturers experiment on malicious code and develop vaccine software in virtual machine environments. That is, malicious code developers have distributed malicious code that behaves unlike intended when a virtual environment is detected in order to avoid the early detection of the malicious code.

However, Crisis directly infected a virtual machine and attempted a frontal breakthrough. Security companies, such as Kaspersky and Symantec, describe that the sphere of activity of the malicious code Crisis has extended up to a VMware virtual machine environment and the malicious code Crisis has had intelligence of stopping its activity when a virtual machine management solution is executed. Accordingly, it is essentially necessary to install an anti-virus program for detecting such malicious code even on a virtual environment. If a plurality of anti-virus programs is installed in a plurality of virtual machines as described above, system performance may be deteriorated due to a resource contention between the virtual machines and there is an increased risk that a user may not properly execute a scheduled check. In order to overcome the problems, a malicious file is not detected within a virtual machine through an execution file extraction technique suitable for a virtualization environment, but the malicious file needs to be analyzed outside the virtual environment.

For example, Korean Patent No. 10-0895102 entitled “System and Method Detection of a File” relates to a method of reconfiguring files over a common network and describes a method that requires hardware help is necessary in order to normally reconfigure a file over a high-speed network. However, conventional techniques operating in a virtual environment are never present.

A conventional method of reconfiguring files over a common network is a method that requires hardware help in order to normally reconfigure a file over a high-speed network. In order to reconfigure a file in a virtualization environment, however, a method needs to be driven only in software without the support of hardware, and there is a need for an efficient file reconfiguration technique that does not affect the function of a virtualization server itself. Furthermore, network packets in a virtualization environment is not transmitted and received over a network as in a common network, but are transmitted and received through the copying of memory within a management OS. Accordingly, there is a need for a packet reconfiguration technique suitable for such a network environment.

### SUMMARY OF THE INVENTION

An object of the present invention is to provide an apparatus and method for extracting packets related to a Windows execution file from network packets, transmitted and received over a virtual network in a server virtualization environment, and reconfiguring execution files.

In accordance with an aspect of the present invention, there is provided a method of reconfiguring execution files in a virtualization environment, including collecting packets transmitted and received through a virtual switch in a virtual environment, extracting an execution file packet including an execution file from the collected packets, sequentially collecting session packets belonging to a session identical with the session of the execution file packet, and reconfiguring the execution file based on a result of check for an application protocol of each of the session packets.

The collecting of the packets corresponds to copying the packets from a region corresponding to the virtual switch within the operating system of the virtual environment.

The extracting of the execution file packet includes checking whether or not the collected packets correspond to packets belonging to a session in which the packets are now being collected and checking whether or not the execution file is present in the packets using a file header signature if, as a result of the check, the collected packets are found to be not packets belonging to the session in which the packets are now being collected.

The header of a network protocol is removed from each of the packets if, as a result of the check, the collected packets are found to be packets belonging to the session in which the packets are now being collected.

The file header signature corresponds to information for detecting the existence of an execution file and is placed at the start point of the execution file.

The reconfiguring of the execution file includes determining whether or not packets to be additionally decoded are present in the session packets based on a result of the check for the application protocol of each of the session packets, decoding the session packets based on decoding information about the application protocols of the session packets, and reconfiguring the execution file of the decoded session packets.

In accordance with an aspect of the present invention, there is provided an apparatus for reconfiguring an execution file in a virtualization environment, including a file check unit for collecting packets transmitted and received through a virtual switch in a virtual environment and extracting an execution file packet including an execution file from the collected packets and a file reconfiguration unit for sequentially collecting session packets belonging to a session identical with the session of the execution file packet and reconfiguring the execution file based on a result of check for an application protocol of each of the session packets.

The file check unit collects the packets transmitted and received through the virtual switch so that the collecting of the packets corresponds to copying the packets from a region corresponding to the virtual switch within the operating system of the virtual environment.

The file check unit includes a session management unit for checking whether or not the collected packets correspond to packets belonging to a session in which the packets are now being collected and a file existence check unit for checking whether or not the execution file is present in the packets using a file header signature if, as a result of the check, the collected packets are found to be not packets belonging to the session in which the packets are now being collected.

The apparatus further includes a header removal unit for removing the header of a network protocol from each of the packets if, as a result of the check of the file existence check unit, the collected packets are found to be packets belonging to the session in which the packets are now being collected.

The file header signature corresponds to information for detecting the existence of an execution file and is placed at the start point of the execution file.

The file reconfiguration unit includes a protocol check unit for determining whether or not packets to be additionally decoded are present in the session packets based on a result of the check for the application protocol of each of the session packets and a protocol decoding unit for decoding the session packets based on decoding information about the application protocols of the session packets, wherein the execution files of the decoded session packets are reconfigured.

### BRIEF DESCRIPTION OF THE DRAWINGS

FIG. 1 is a diagram showing a server virtualization environment in accordance with an embodiment of the present invention;

FIG. 2 is a diagram showing an apparatus for reconfiguring execution files in a virtualization environment in accordance with an embodiment of the present invention;

FIG. 3 is a diagram showing the construction of a file check unit in accordance with an embodiment of the present invention;

FIG. 4 is a diagram showing a PE file header in accordance with an embodiment of the present invention;

FIG. 5 is a diagram showing file reconfiguration information in accordance with an embodiment of the present invention;

FIG. 6 is a diagram showing the construction of a file reconfiguration unit in accordance with an embodiment of the present invention;

FIG. 7 is a flowchart illustrating a process of checking whether or not execution files are present in packets in accordance with an embodiment of the present invention;

FIG. 8 is a flowchart illustrating a process of reconfiguring files in accordance with an embodiment of the present invention; and

FIG. 9 is a diagram schematically showing a method of reconfiguring execution files in a virtualization environment in accordance with an embodiment of the present invention.

### DETAILED DESCRIPTION OF THE EMBODIMENTS

Hereafter, the present invention is described in detail with reference to the accompanying drawings. Repeated descriptions and descriptions of known functions and constructions which are deemed to make the gist of the present invention unnecessarily vague are omitted below. The embodiments of the present invention are provided in order to fully describe the present invention to those skilled in the art. Accordingly, the shapes, sizes, etc. of elements in the drawings may be enlarged for clarity of description.

An apparatus and method for reconfiguring execution files in a virtualization environment according to some exemplary embodiments of the present invention are described in detail below with reference to the accompanying drawings.

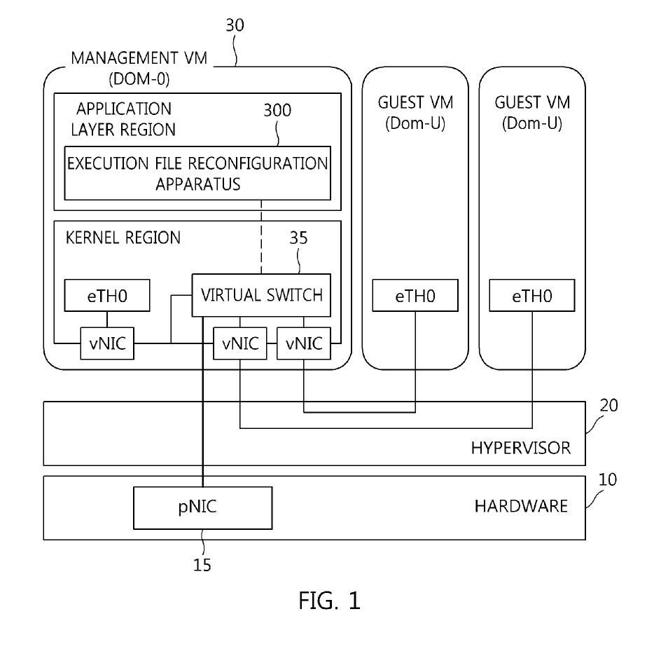

FIG. 1 is a diagram showing a server virtualization environment in accordance with an embodiment of the present invention.

First, the present invention is related to detecting the existence of a file executable in a computer within corresponding packets from network packets that are transmitted and received over a virtual network in a server virtualization environment and generating a complete file by reconfiguring the corresponding file if, as a result of the detection, the corresponding file is present. Here, the server virtualization environment and the virtual network are diagrammed in FIG. 1, and a description is given based on the server virtualization environment.

Referring to FIG. 1, a server virtualization environment (hereinafter also called a “virtualization environment”) means an environment in which a plurality of virtual machines operates in one physical system, that is, in hardware 10. Here, each of the plurality of virtual machines is a virtual system in which its own OS can be installed.

In such a virtualization environment, in order to share and use a piece of hardware, a hypervisor 20 for setting priority for the use of the hardware and assigning hardware suitable for a virtual machine to be used is installed in the upper stage of the hardware 10.

Since a plurality of virtual machines is installed in a virtualization environment, a virtual switch 35 needs to be installed in a management VM 30 so that each of the plurality of virtual machines accesses the Internet. The management VM 30 is divided into an application layer region and a kernel region.

The virtual switch 35 placed in the kernel region is connected to the network interface cards vNIC of the virtual machine, and thus packets can be transmitted to an actual physical network interface card pNIC 15 through the network interface cards.

The virtual switch 35 is not an actual network switch, but it corresponds to a kind of application implemented so that a guest VM communicates with the outside over a network. Here, network packets used are delivered to the physical network interface card 15 through the copying of the packets on memory.

In the present invention, as described above, whether or not an executable file is present, that is, the existence of an execution file, is determined by checking network packets, and the execution file is reconfigured into an executable file by reconfiguring the execution file if, as a result of the check, the execution file is found to be present. To this end, an apparatus for reconfiguring the execution file in a virtualization environment in accordance with an embodiment of the present invention may be applied to the application layer region of the management VM 30, but the present invention is not limited thereto.

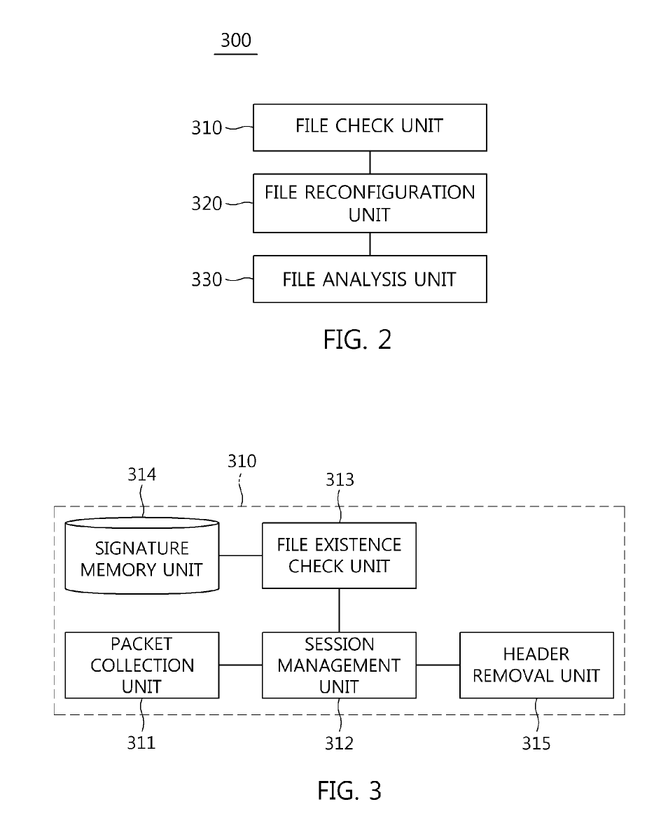

The apparatus for reconfiguring an execution file in a virtualization environment is described in detail below with reference to FIG. 2.

FIG. 2 is a diagram showing the apparatus for reconfiguring the execution file in a virtualization environment in accordance with an embodiment of the present invention.

Referring to FIG. 2, the apparatus for reconfiguring the execution file in a virtualization environment (hereinafter also called the “execution file reconfiguration apparatus”) 300 includes a file check unit 310, a file reconfiguration unit 320, and a file analysis unit 330.

The file check unit 310 collects packets transmitted and received through the virtual switch 35 and checks whether or not an execution file is present in specific packets of the collected packets. The file check unit 310 transfers the data region of packets, including the execution file, to the file reconfiguration unit 320.

The file reconfiguration unit 320 sequentially collects packets that belong to the session of the packets including the execution file as a result of the check of the file check unit 310 and reconfigures the execution file based on a result of checking the application protocol of the collected packets.

The file analysis unit 330 analyzes the execution file reconfigured by the file reconfiguration unit 320 in detail. For example, the file analysis unit 330 may correspond to a specific system for performing various functions through file analyses, such as an intrusion detection system or an anti-virus system, but the intrusion detection system or the anti-virus system is not an element directly included in the present invention.

The file check unit 310 is described in detail below with reference to FIG. 3.

FIG. 3 is a diagram showing the construction of the file check unit in accordance with an embodiment of the present invention.

Referring to FIG. 3, the file check unit 310 includes a packet collection unit 311, a session management unit 312, a file existence check unit 313, a signature memory unit 314, and a header removal unit 315.

The packet collection unit 311 collects network packets (hereinafter also called “packets”) transmitted and received through the virtual switch 35 and transfers the collected packets to the session management unit 312. The packet collection unit 311 does not access an actual network in order to collect network packets from the virtual switch 35, but copies the packets from a region that corresponds to the virtual switch 35 within the OS of a virtual environment.

The session management unit 312 assumes that execution files are included in packets received from the packet collection unit 311 and checks whether or not the received packets are packets that belong to a session in which packets are being collected.

More particularly, the session management unit 312 transfers the received packets to the header removal unit 315 if, as a result of the check, the received packets are found to be packets belonging to the session in which packets are being collected.

If, as a result of the check, the received packets are found to be not packets belonging to the session in which packets are being collected, the session management unit 312 transfers the received packets to the file existence check unit 313 so that the file existence check unit 313 can check whether or not an execution file is present in the received packets. If, as a result of the check, the execution file is found to be present in the received packets, the session management unit 312 transfers the received packets to the header removal unit 315 and performs a configuration so that packets continue to be collected in the corresponding session.

The file existence check unit 313 checks whether or not an execution file is present in the packets using a file header signature stored in the signature memory unit 314 and transfers a result of the check to the session management unit 312.

The signature memory unit 314 stores a predetermined file header signature. The file header signature includes information for detecting the existence of an execution file.

An execution file used in a computer includes a file header. The file header is a portion placed at the start point of the execution file so that the execution file is normally executed on a specific OS. For example, in a file used by a specific application program, information related to the file is stored in a file header in order to represent that the file is managed by the specific application program. As described above, a file header is defined by each OS. In order for a user to normally generate and use a specific file, the user must apply and use a defined file header. In the present invention, a file header is used as a signature for detecting an execution file.

Although the detection of an execution file is described in the present invention, the existence of an execution file can be determined based on information within a corresponding file header in relation to all files having patterned file headers and files can be reconfigured depending on the characteristics of information. Accordingly, if the technique of the present invention is used, various applications are made possible.

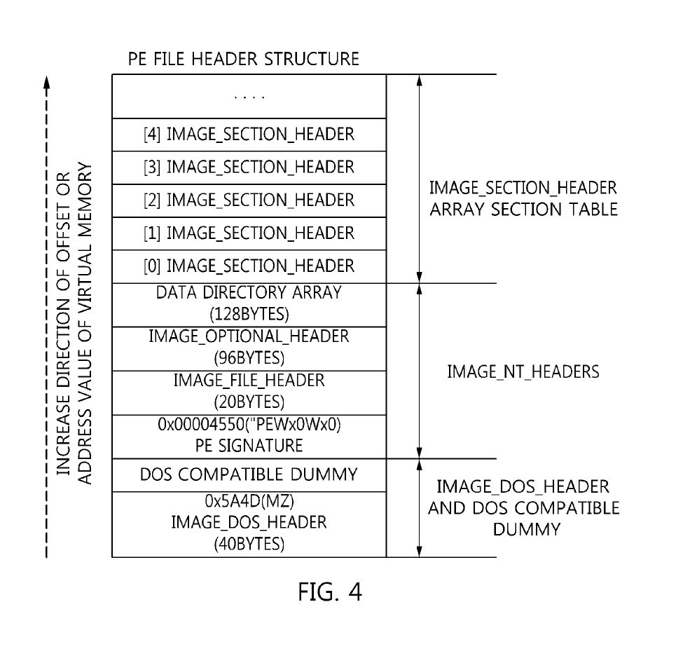

A Potable Executable (PE) file header corresponding to the execution file of Windows OS by Microsoft, that is, an OS most widely used in a current information communication environment, is shown in FIG. 4.

Referring to FIG. 4, the PE file header includes a “0x5A4D(MZ)” value of an IMAGE_DOS_HEADER part and “0x00004550(00PE)”, that is, the PE signature of IMAGE_NT_HEADERS.

In the present invention, a file signature that defines a specific file is generated using information within a file header that cannot be modified, the generated file signature is previously stored in the signature memory unit 314, and the stored file signature is used to detect an execution file.

If a file signature generated using information that cannot be modified is stored in the signature memory unit 314, the file signature is previously generated using an encoding process used in a corresponding application protocol, if necessary, in the case of a specific application protocol. Here, the encoding of the application protocol means a widely known encoding method and means the MIME and UNIC ODE encoding of SMTP and BASE64 encoding on which corresponding encoding information can be decoded.

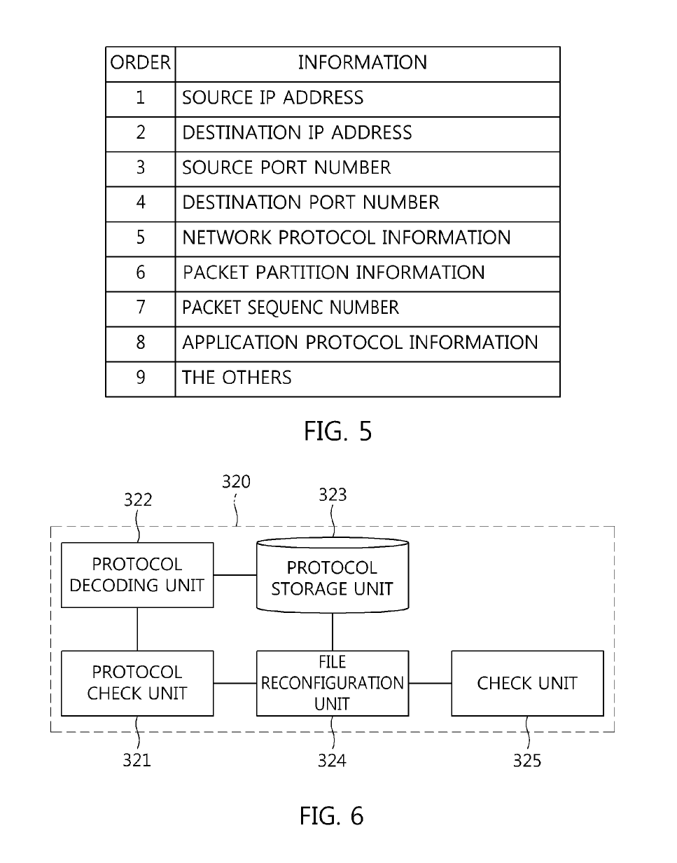

The header removal unit 315 removes the header of a network protocol (e.g., Ethernet, IP, TCP, or UDP) from each of the packets received from the session management unit 312 and transfers the data region (i.e., payload) part of the packets to the file reconfiguration unit 320. The header removal unit 315 also transfers file reconfiguration information necessary to reconfigure files, included in the removed header, to the file reconfiguration unit 320. The file reconfiguration information includes pieces of information, such as those of FIG. 5. In accordance with an embodiment of the present invention, new information may be added to the file reconfiguration information or some of the pieces of information included in the file reconfiguration information may be modified or deleted, but the present invention is not limited thereto.

The file reconfiguration unit 320 is described in detail below with reference to FIG. 6.

FIG. 6 is a diagram showing the construction of the file reconfiguration unit in accordance with an embodiment of the present invention.

Referring to FIG. 6, the file reconfiguration unit 320 includes a protocol check unit 321, a protocol decoding unit 322, a protocol storage unit 323, a file reconfiguration unit 324, and a check unit 325.

The protocol check unit 321 checks an application protocol on which packets are transmitted and received, based on packets from which a header has been removed and which has been received from the file check unit 310 and file reconfiguration information and transfers the packets to the protocol decoding unit 322 if additional decoding is necessary based on a result of the check. Furthermore, the protocol check unit 321 transfers packets on which decoding has been completed and packets that do not need to be decoded, received from the protocol decoding unit 322, to the file reconfiguration unit 324.

The protocol decoding unit 322 checks packets received from the protocol check unit 321 using information about application protocols and additionally decodes the received packets based on a result of the check. The protocol decoding unit 322 receives a result of the check, that is, decoding information about the application protocols of the packets, from the protocol storage unit 323 and decodes the received packets based on the decoding information. The application protocol on which the packet is decoded includes the MIME and UNICODE of SMTP and BASE64.

Next, the protocol decoding unit 322 transfers the packets on which decoding has been completed to the protocol check unit 321.

The protocol storage unit 323 stores decoding information about the application protocols of the packets. Furthermore, the protocol storage unit 323 provides decoding information that is necessary for the protocol decoding unit 322 to perform decoding.

The file reconfiguration unit 324 generates a complete file by reconfiguring execution files included in packets, received from the protocol check unit 321, based on file reconfiguration information, such as that of FIG. 5.

More particularly, the file reconfiguration unit 324 does not sequentially assemble packets simply, but reconfigure execution files included in packets in order that packets are received. For example, if packets are received using the UDP, the file reconfiguration unit 324 reconfigures execution files included in the packets using information about the fragment data of an IP header. If packets are received using the TCP, the file reconfiguration unit 324 reconfigures execution files included in the packets based on information about the sequence number. If such a method is used, files are reconfigured in the same order that files intended by a user are transmitted.

A common execution file may not be included in one network packet because it has a size of 1500 bytes or more. Accordingly, the common execution file is transferred through a plurality of network packets. The execution file that is divided and transmitted as described above is sequentially transmitted. Accordingly, if the header parts of corresponding network packets are removed and reassembled to order, a complete file can be reconfigured. The reconfigured file is transferred to the check unit 325 in order to check the accuracy of the file.

The check unit 325 verifies the accuracy of the execution file in order to determine whether or not the execution file reconfigured by the file reconfiguration unit 324 has been normally generated. The check unit 325 may transfer the verified execution file to other systems (e.g., an intrusion detection system and an anti-virus system) so that additional verification can be performed.

More particularly, the check unit 325 checks whether or not the execution file received from the file reconfiguration unit 324 has been normally reconfigured by analyzing the execution file. The check unit 325 analyzes whether or not header information is precisely identical with the reconfigured file based on various pieces of information included in the header of the execution file. When checking the accuracy of the execution file, header information that is not fixed is used unlike in a file signature. For example, in the case of the PE file, the name of each session is stored in IMAGE_SECTION_HEADER of the PE file header. A name needs to include the same name at the start point of a corresponding section. Whether or not the entire file has been normally reconfigured can be checked based on the name.

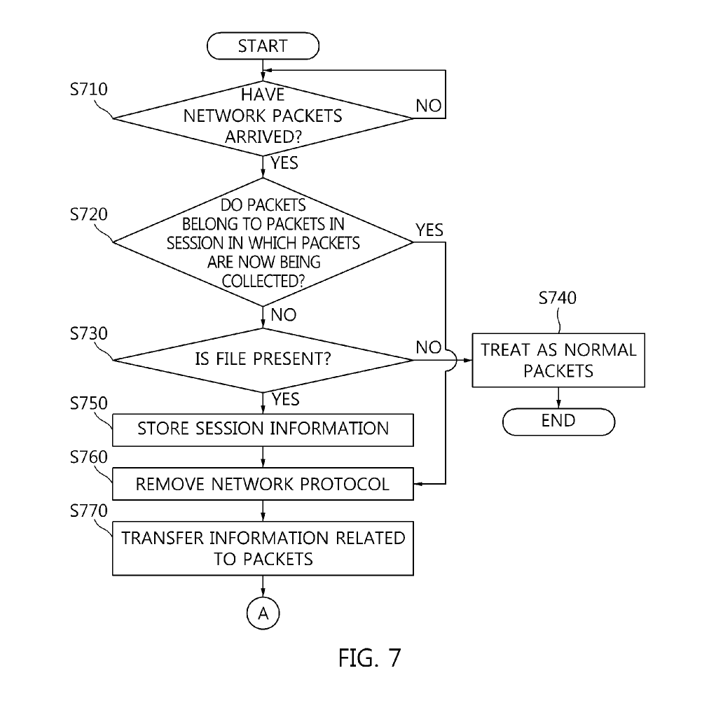

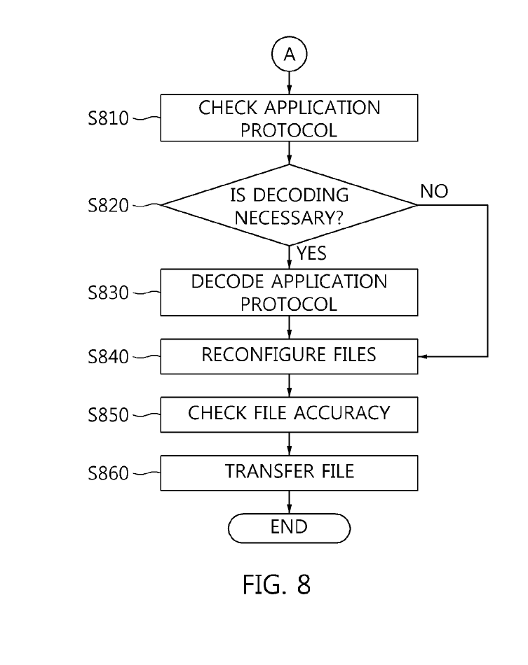

A method of reconfiguring execution files in a virtualization environment is described in detail below with reference to FIGS. 7 and 8.

First, the method of reconfiguring execution files in a virtualization environment basically includes a process of checking, by the file check unit 310, whether or not execution files are present in packets and a process of reconfiguring, by the file reconfiguration unit 320, the files of packets including execution files.

FIG. 7 is a flowchart illustrating a process of checking whether or not execution files are present in packets in accordance with an embodiment of the present invention.

Referring to FIG. 7, the file check unit 310 waits until network packets (hereinafter also called “packets”) arrives at step S710.

The file check unit 310 checks whether or not packets transmitted and received through the virtual switch 35 are packets belonging to a session in which the packets are collected at step S720.

If, as a result of the check at step S720, the packets transmitted and received through the virtual switch 35 are found to be packets belonging to the session in which the packets are collected, the file check unit 310 removes the header of a network protocol from each of the packets.

If, as a result of the check at step S720, the packets transmitted and received through the virtual switch 35 are found to be not packets belonging to the session in which the packets are collected, the file check unit 310 checks whether or not execution files are present in the packets using a file header signature at step S730.

If, as a result of the check at step S730, execution files are found to be not present in the packets, the file check unit 310 treats the packets as normal packets at step S740.

If, as a result of the check at step S730, execution files are found to be present in the packets, the file check unit 310 stores session information for the packets at step S750 and removes the header of a network protocol from each of the packets at step S760.

The file check unit 310 transfers the packets from which the headers of the network protocols have been removed and information related to the packets, that is, file reconfiguration information, to the file reconfiguration unit 320 at step S770.

FIG. 8 is a flowchart illustrating a process of reconfiguring files in accordance with an embodiment of the present invention.

Referring to FIG. 8, the file reconfiguration unit 320 checks an application protocol on which a packet is transmitted and received, based on the packets from which the headers of the network protocols have been removed and that have been received at step S770 and the file reconfiguration information at step S810.

At step S820, the file reconfiguration unit 320 determines whether or not to additionally decode the packets based on a result of the check at step S810.

If, as a result of the determination at step S820, it is determined that the packets need to be additionally decoded, the file reconfiguration unit 320 decodes the packets based on decoding information about the application protocols of the packets at step S830. Here, the application protocol on which the packet is decoded includes MIME and UNICODE of SMTP and BASE64.

Next, at step S840, the file reconfiguration unit 320 reconfigures packets that do not need to be additionally decoded at step S810 or the execution files of the packets decoded at step S830.

At step S840, the file reconfiguration unit 320 does not sequentially assemble the packets, but reconfigures the execution files of the packets in order that the packets are received. For example, if the packets are received using the UDP, the file reconfiguration unit 324 reconfigures the execution files of the packets using information about the fragment data of an IP header. If the packets are received using the TCP, the file reconfiguration unit 324 reconfigures the execution files of the packets based on information about the sequence number. If such a method is used, files are reconfigured in the same order that files intended by a user are transmitted.

The file reconfiguration unit 320 checks the accuracy of the execution file in order to determine whether or not the reconfigured execution file has been normally generated at step S850.

At step S860, the file reconfiguration unit 320 may transfer the execution file whose accuracy has been verified at step S850 to other systems (e.g., an intrusion detection system and an anti-virus system) so that additional verification can be performed.

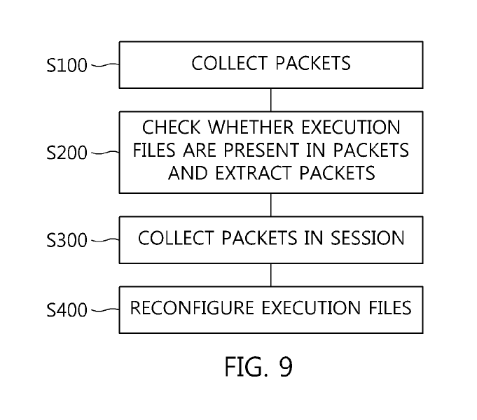

The process of checking, by the file check unit 310, whether or not execution files are present in packets in FIG. 7 and the process of reconfiguring, by the file reconfiguration unit 320, the files of packets including execution files in FIG. 8 may be united and schematically illustrated in FIG. 9.

FIG. 9 is a diagram schematically showing a method of reconfiguring execution files in a virtualization environment in accordance with an embodiment of the present invention.

Referring to FIG. 9, the apparatus for reconfiguring execution files in a virtualization environment (hereinafter also called the “execution file reconfiguration apparatus”) 300 collects packets transmitted and received through the virtual switch 35 at step S100.

The execution file reconfiguration apparatus 300 extracts packets including execution files, that is, execution file packets, from the packets collected at step S100 at step S200.

The execution file reconfiguration apparatus 300 sequentially collects packets belonging to the session of the execution file packets extracted at step S200, that is, session packets, at step S300.

At step S400, the execution file reconfiguration apparatus 300 reconfigures the execution files based on a result obtained by checking the application protocol of each of the session packets collected at step S300.

As described above, the present invention discloses a packet collection and execution file reconfiguration method through the virtual switch for extracting Windows execution files in a virtualization environment. Accordingly, various Windows execution files that can be analyzed only in each virtual machine can be independently analyzed in specific virtual machines by tracking only packets related to a Windows execution file, of network packets received through the virtual switch.

Furthermore, the present invention is advantageous in that Windows execution files transferred on all virtual machines can be extracted because packets are collected and reconfigured on a virtual switch. This provides a base on which various file analysis schemes can be used because an execution file having a complete form can be extracted. Accordingly, the present invention provides a base on which a Windows execution file can be extracted in the early stage through the virtual switch not in each virtual machine and viruses, worms, and malicious code, such as Trojan, based on execution files in a virtualization environment can be detected and handled in the early stage.

In accordance with the present invention, various Windows execution files that can be analyzed only in each virtual machine can be analyzed independently from a specific virtual machine by tracking packets related to a Windows execution file, of network packets received through the virtual switch.

That is, the present invention is advantageous in that Windows execution files transferred on all virtual machines can be extracted by collecting and reconfiguring packets on the virtual switch.

The exemplary embodiments have been disclosed in the drawings and specification. Specific terms have been used herein, but the terms are used to only describe the present invention, but are not used to limit the meaning of the terms or the scope of the present invention written in the claim. Accordingly, those skilled in the art will understand that various modifications and other equivalent embodiments are possible from the present invention. Accordingly, the true technical scope of the present invention should be determined by the following claims.

What is claimed is:

1. A method of reconfiguring execution files, comprising:
collecting packets transmitted and received through a virtual switch in a virtual environment;
extracting an execution file packet comprising an execution file from the collected packets;
sequentially collecting session packets belonging to a session identical with a session of the execution file packet; and
reconfiguring the execution file based on a result of check for an application protocol of each of the session packets.

2. The method of claim 1, wherein the collecting of the packets corresponds to copying the packets from a region corresponding to the virtual switch within an operating system of the virtual environment.

3. The method of claim 1, wherein the extracting of the execution file packet comprises:
checking whether or not the collected packets correspond to packets belonging to a session in which the packets are now being collected; and
checking whether or not an execution file is present in the packets using a file header signature if, as a result of the check, the collected packets are found to be not packets belonging to the session in which the packets are now being collected.

4. The method of claim 3, wherein a header of a network protocol is removed from each of the packets if, as a result of the check, the collected packets are found to be packets belonging to the session in which the packets are now being collected.

5. The method of claim 3, wherein the file header signature corresponds to information for detecting an existence of an execution file and is placed at a start point of the execution file.

6. The method of claim 1, wherein the reconfiguring of the execution file comprises:
determining whether or not packet to be additionally decoded is present in the session packets based on a result of the check for the application protocol of each of the session packets;
decoding the session packets based on decoding information corresponding to the application protocols of the session packets; and
reconfiguring the execution files of the decoded session packets.

7. An apparatus for reconfiguring execution files, comprising:
a file check unit for collecting packets transmitted and received through a virtual switch in a virtual environment and extracting execution file packet comprising execution file from the collected packets; and
a file reconfiguration unit for sequentially collecting session packets belonging to a session identical with a session of the execution file packet and reconfiguring the execution file based on a result of check for an application protocol of each of the session packets.

8. The apparatus of claim 7, wherein the file check unit collects the packets transmitted and received through the virtual switch so that the collecting of the packets corresponds to copying the packets from a region corresponding to the virtual switch within an operating system of the virtual environment.

9. The apparatus of claim 7, wherein the file check unit comprises:
a session management unit for checking whether or not the collected packets correspond to packets belonging to a session in which the packets are now being collected; and
a file existence check unit for checking whether or not an execution file is present in the packets using a file header signature if, as a result of the check, the collected packets are found to be not packets belonging to the session in which the packets are now being collected.

10. The apparatus of claim 9, further comprising a header removal unit for removing a header of a network protocol from each of the packets if, as a result of the check of the file existence check unit, the collected packets are found to be packets belonging to the session in which the packets are now being collected.

11. The apparatus of claim 10, wherein the file header signature corresponds to information for detecting an existence of an execution file and is placed at a start point of the execution file.

12. The apparatus of claim 8, wherein the file reconfiguration unit comprises:
a protocol check unit for determining whether or not packets to be additionally decoded are present in the session packets based on a result of the check for the application protocol of each of the session packets; and
a protocol decoding unit for decoding the session packets based on decoding information corresponding to the application protocols of the session packets,
wherein the execution files of the decoded session packets are reconfigured.
